(19) United States
(12) Patent Application Publication
(10) Pub. No.: US 2020/0026165 A1
(43) Pub. Date: Jan. 23, 2020

(54) STRUCTURED LIGHT PROJECTING APPARATUS

(71) Applicant: Guangzhou Tyrafos Semiconductor Technologies Co., Limited, Guangzhou (CN)

(72) Inventors: Hsu-Wen Fu, Kaohsiung City (TW); Chun-Yu Lee, New Taipei City (TW); Jun-Wen Chung, Tainan City (TW); Ping-Hung Yin, Taipei City (TW)

(73) Assignee: Guangzhou Tyrafos Semiconductor Technologies Co., Limited, Guangzhou (CN)

(21) Appl. No.: 16/382,213

(22) Filed: Apr. 12, 2019

(30) Foreign Application Priority Data
Jul. 19, 2018 (TW) 107124977

(51) Int. Cl. G03B 21/14; G02B 27/10; G02B 7/02; G02B 27/30; G03B 21/28

(52) U.S. Cl. CPC G03B 21/142; G02B 27/106; G03B 21/28; G02B 27/1086; G02B 27/30; G02B 7/021

(57) ABSTRACT

A structured light projecting apparatus including a light source module, a beam splitting element, and first and second diffraction optical elements is provided. The light source emits a light beam. The beam splitting element is disposed on a transmission path of the light beam, and splits the light beam into first and second portion light beams. The first diffraction optical element is disposed on a transmission path of the first portion light beam. Multiple light beams are produced after the first portion light beam passes through the first diffraction optical element, so as to form a first structured light. The second diffraction optical element is disposed beside the first diffraction optical element and on a transmission path of the second portion light beam. Multiple light beams are produced after the second portion light beam passes through the second diffraction optical element, so as to form a second structured light.

### CROSS-REFERENCE TO RELATED APPLICATION

This application claims the priority benefit of Taiwan application serial no. 107124977, filed on Jul. 19, 2018. The entirety of the above-mentioned patent application is hereby incorporated by reference herein and made a part of this specification.

### BACKGROUND

### Technical Field

The invention relates to a light projecting apparatus, and particularly relates to a structured light projecting apparatus.

### Description of Related Art

Structured light sensing device measures a surface profile of an object by projecting structured light with a special pattern onto the object and sensing a deformation of the special pattern projected to the object. Generally, a diffraction optical element may be disposed on a light source, such as a laser light source, and by means of the diffraction optical element, a laser beam may produce the structured light with the special pattern.

In order to make the measurement more accurate, two groups of different diffraction optical elements may be adopted to generate two groups of structured light with different patterns. However, the two groups of diffraction optical elements should be correspondingly configured with two groups of laser light sources, which results in a larger volume and high cost.

### SUMMARY

An embodiment of the invention provides a structured light projecting apparatus, which has a smaller volume and lower cost.

An embodiment of the invention provides a structured light projecting apparatus including a light source module, a beam splitting element, a first diffraction optical element, a second diffraction optical element, a first lens module and a second lens module. The light source is configured to emit a light beam. The beam splitting element is disposed on a transmission path of the light beam and is configured to split the light beam into a first portion light beam and a second portion light beam. The first diffraction optical element is disposed on a transmission path of the first portion light beam. A plurality of light beams separated from each other are produced after the first portion light beam passes through the first diffraction optical element, so as to form a first structured light. The second diffraction optical element is disposed beside the first diffraction optical element and disposed on a transmission path of the second portion light beam. A plurality of light beams separated from each other are produced after the second portion light beam passes through the second diffraction optical element, so as to form a second structured light. The first lens module and the second lens module are respectively disposed on the transmission paths of the first portion light beam and the second portion light beam. Each of the first lens module and the second lens module includes a diverging lens and a converging lens, wherein the first lens module and the second lens module are used for at least one of light beam shaping and light beam collimation, and the first lens module and the second lens module respectively expand the first portion light beam and the second portion light beam via the respective diverging lenses.

In an embodiment of the invention, the beam splitting element includes a transflective element and a reflecting element. The transflective element is disposed on the transmission path of the light beam, wherein the first portion light beam of the light beam is reflected by the transflective element and transmitted to the first diffraction optical element, and the second portion light beam of the light beam passes through the transflective element. The reflecting element is disposed on a transmission path of the second portion light beam passing through the transflective element, and the second portion light beam is reflected by the reflecting element and transmitted to the second diffraction optical element.

In an embodiment of the invention, light intensities of the first portion light beam and the second portion light beam are the same.

In an embodiment of the invention, light intensities of the first portion light beam and the second portion light beam are different.

An embodiment of the invention provides a structured light projecting apparatus including a light source module, a first diffraction optical element, a second diffraction optical element, a first lens module and a second lens module. The light source has a first light-emitting portion and a second light-emitting portion, the first light-emitting portion is configured to emit a first portion light beam, and the second light-emitting portion is configured to emit a second portion light beam. The first diffraction optical element is disposed on a transmission path of the first portion light beam. A plurality of light beams separated from each other are produced after the first portion light beam passes through the first diffraction optical element, so as to form a first structured light. The second diffraction optical element is disposed beside the first diffraction optical element and disposed on a transmission path of the second portion light beam. A plurality of light beams separated from each other are produced after the second portion light beam passes through the second diffraction optical element, so as to form a second structured light. The first lens module and the second lens module are respectively disposed on the transmission paths of the first portion light beam and the second portion light beam. Each of the first lens module and the second lens module includes a diverging lens and a converging lens, wherein the first lens module and the second lens module are used for at least one of light beam shaping and light beam collimation, and the first lens module and the second lens module respectively expand the first portion light beam and the second portion light beam via the respective diverging lenses. One of the following is true: (1) At least one of the first portion light beam and the second portion light beam has a wavelength greater than or equal to 910 nm and smaller than or equal to 970 nm, or (2) at least one of the first portion light beam and the second portion light beam has a wavelength greater than or equal to 1330 nm and smaller than or equal to 1370 nm.

In an embodiment of the invention, wavelengths of the first portion light beam and the second portion light beam are the same.

In an embodiment of the invention, wavelengths of the first portion light beam and the second portion light beam are different.

In an embodiment of the invention, the first diffraction optical element and the second diffraction optical element have different diffraction patterns.

According to the above description, the structured light projecting apparatus of the embodiment of the invention adopts two groups of diffraction optical elements, and uses two simple ways to respectively provide the first portion light beam and the second portion light beam to the first diffraction optical element and the second diffraction optical element. The first way is to use the beam splitting element to split the light beam emitted from the light source module into the first portion light beam and the second portion light beam. The second way is that the single light source module may include the first light-emitting portion and the second light-emitting portion capable of respectively emitting the first portion light beam and the second portion light beam. Therefore, the structured light projecting apparatus of the embodiment of the invention is unnecessary to configure two groups of light source modules to respectively correspond to the two groups of diffraction optical elements, which avails saving a volume and reduce the cost.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural schematic diagram of a structured light projecting apparatus according to an embodiment of the invention.

FIG. 2A to FIG. 2C are schematic diagrams of patterns of first structured light or patterns of second structured light according to some embodiments of the invention.

FIG. 3 is a structural schematic diagram of a structured light projecting apparatus according to another embodiment of the invention.

### DESCRIPTION OF THE EMBODIMENTS

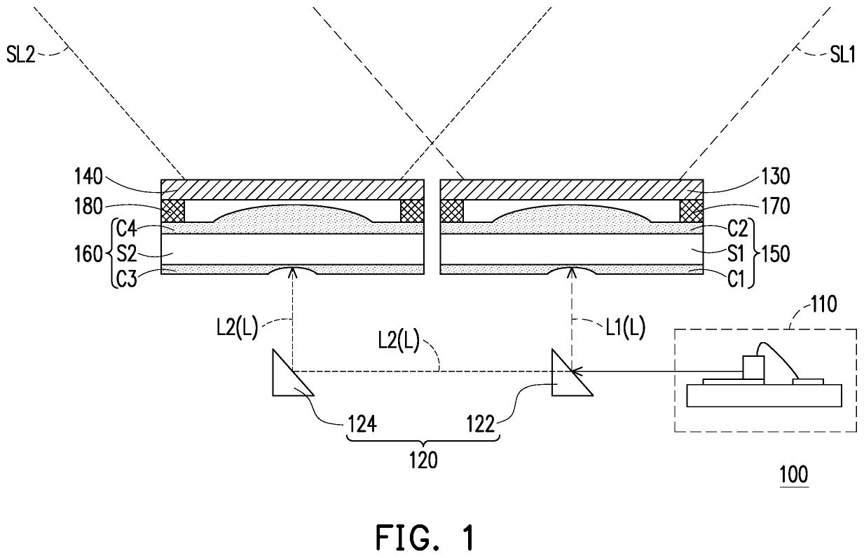

FIG. 1 is a structural schematic diagram of a structured light projecting apparatus according to an embodiment of the invention. Referring to FIG. 1, the structured light projecting apparatus 100 of the embodiment includes a light source module 110, a beam splitting element 120, a first diffraction optical element 130 and a second diffraction optical element 140. The light source 110 is configured to emit a light beam L. The beam splitting element 120 is disposed on a transmission path of the light beam L, and is configured to split the light beam L into a first portion light beam L1 and a second portion light beam L2. The first diffraction optical element 130 is disposed on a transmission path of the first portion light beam L1, and a plurality of light beams separated from each other are produced after the first portion light beam L1 passes through the first diffraction optical element 130, so as to form a first structured light SL1. The second diffraction optical element 140 is disposed beside the first diffraction optical element 130 and disposed on a transmission path of the second portion light beam L2, and a plurality of light beams separated from each other are produced after the second portion light beam L2 passes through the second diffraction optical element 140, so as to form a second structured light SL2. In the embodiment, the light source module 110 is, for example, an Edge Emitting Laser (EEL) or other proper light source.

To be specific, the beam splitting module 120 includes a transflective element 122 and a reflecting element 124. The transflective element 122 is disposed on the transmission path of the light beam L, where the first portion light beam L1 of the light beam L is reflected by the transflective element 122 and transmitted to the first diffraction optical element 130, and the second portion light beam L2 of the light beam L passes through the transflective element 122. The reflecting element 124 is disposed on a transmission path of the second portion light beam L2 passing through the transflective element 122, and the second portion light beam L2 is reflected by the reflecting element 124 and transmitted to the second diffraction optical element 140. In other words, after the light beam L emitted from the light source module 110 is transmitted to the transflective element 122, the first portion light beam L1 is reflected by the transflective element 122, so as to be transmitted to the first diffraction optical element 130, and the second portion light beam L2 passes through the transflective element 122, is transmitted to the reflecting element 124 and reflected by the reflecting element 124 in sequence, so as to be transmitted to the second diffraction optical element 140.

In the embodiment, the beam splitting module 120 splits the light beam L emitted from the light source module 110 into the first portion light beam L1 and the second portion light beam L2, and it is unnecessary to configure two groups of light source modules to respectively correspond to the two groups of diffraction optical elements, which avails saving a volume and reduce the cost.

In the embodiment, light intensities of the first portion light beam L1 and the second portion light beam L2 may be the same or different. In detail, if a reflectivity of the transflective element 122 is R %, and a transmittance thereof is 1-R %, the light intensity of the first portion light beam L1 is about I₀*R %, and the light intensity of the second portion light beam L2 is about I₀*(1−R %), where I₀ is a light intensity of the light beam L. Therefore, the light intensities of the first portion light beam L1 and the second portion light beam L2 may be modulated by controlling the reflectivity (or transmittance) of the transflective element 122. If the light intensities of the first portion light beam L1 and the second portion light beam L2 are different, it avails improving distinguishability between the first structured light SL1 and the second structured light SL2 projected by the structured light projecting apparatus 100. In the embodiment, the transflective element 122 is, for example, a prism plated with a transflective film, and the reflecting element 124 is, for example, a prism plated with a reflecting film. In other embodiments, the reflecting element 124 may be a reflecting mirror, a Total Internal Reflection (TIR) prism or other proper reflecting optical element.

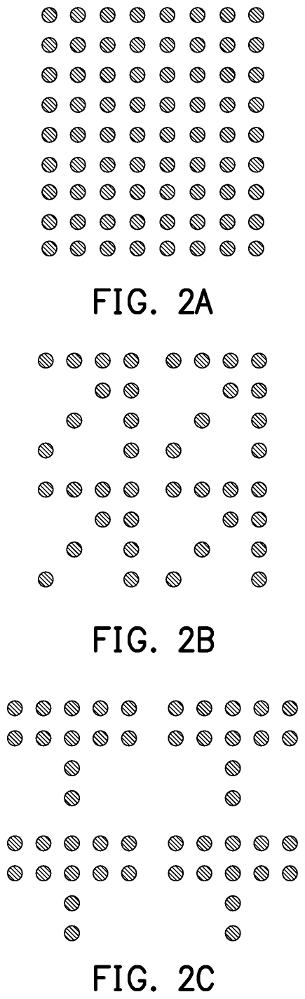

FIG. 2A to FIG. 2C are schematic diagrams of patterns of the first structured light or patterns of the second structured light according to some embodiments of the invention. In the embodiment, the first diffraction optical element 130 and the second diffraction optical element 140, for example, have different diffraction patterns, such that the projected first structured light SL1 and second structured light SL2 may have different patterns. For example, as shown in FIG. 2A, a light pattern formed by the projected first structured light SL1 or second structured light SL2 on a screen may be a regularly arranged dot pattern. As shown in FIG. 2B, the light pattern may be a pattern presenting a plurality of arrows arranged in an array. As shown in FIG. 2C, the light pattern may be a pattern presenting a plurality of T-shapes arranged in an array. However, in other embodiments, the light pattern formed by projecting the first structured light SL1 or the second structured light SL2 on the screen may have other patterns, and may be regularly arranged or irregularly arranged, but is not limited thereto. Since the first structured light SL1 and the second structured light SL2 may have different patterns, a measurement result may be more accurate.

Referring to FIG. 1, the structured light projecting apparatus 100 of the embodiment further includes a first lens module 150 and a second lens module 160, which are respectively disposed on transmission paths of the first portion light beam L1 and the second portion light beam L2, and the first lens module 150 and the second lens module 160 are used for at least one of light beam shaping and light beam collimation. In detail, the first lens module 150 is disposed between the first diffraction optical element 130 and the transflective element 122, and the second lens module 160 is disposed between the second diffraction optical element 140 and the reflecting element 124. The first lens module 150 is, for example, connected to the first diffraction optical element 130 through a connection unit 170. The second lens module 160 is, for example, connected to the second diffraction optical element 140 through a connection unit 180.

In the embodiment, the first lens module 150 may include a diverging lens C1 and a converging lens C2, and the diverging lens C1 and the converging lens C2 are sequentially disposed on the transmission path of the first portion light beam L1, where the diverging lens C1 is used for expanding the first portion light beam L1, and the converging lens C2 is used for collimating the expanded first portion light beam L1. The second lens module 160 may also include a diverging lens C3 and a converging lens C4, and the diverging lens C3 and the converging lens C4 are sequentially disposed on the transmission path of the second portion light beam L2, where the diverging lens C3 is used for expanding the second portion light beam L2, and the converging lens C4 is used for collimating the expanded second portion light beam L2. In the embodiment, the diverging lens C1 and the converging lens C2 are, for example, respectively formed on two sides of a substrate S1 through imprinting processes. The diverging lens C3 and the converging lens C4 are, for example, respectively formed on two sides of a substrate S2 through imprinting processes.

It is to be noted that the following embodiments use parts of the foregoing embodiments, and the description of the same technical content is omitted. For the same component names, reference may be made to parts of the foregoing embodiments and are not repeated in the following embodiments.

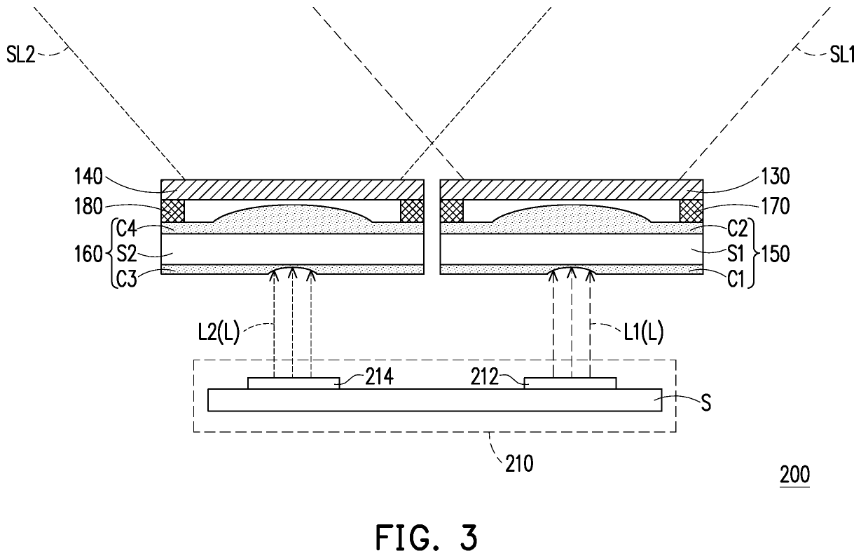

FIG. 3 is a structural schematic diagram of a structured light projecting apparatus according to another embodiment of the invention. Referring to FIG. 3, a light source module 210 of a structured light projecting apparatus 200 of the embodiment has a first light-emitting portion 212 and a second light-emitting portion 214 disposed on the substrate S, where the first light-emitting portion 212 is disposed corresponding to the first diffraction optical element 130, and the second light-emitting portion 214 is disposed corresponding to the second diffraction optical element 140. The first light-emitting portion 212 is configured to emit a first portion light beam L1, and transmit the first portion light beam L1 to the first diffraction optical element 130. The second light-emitting portion 214 is configured to emit a second portion light beam L2, and transmit the second portion light beam L2 to the second diffraction optical element 140. In the embodiment, the light source module 210 is, for example, a Vertical-Cavity Surface-Emitting Laser (VCSEL) module.

The light source module 210 of the embodiment has the first light-emitting portion 212 and the second light-emitting portion 214 adapted to respectively emit the first portion light beam L1 and the second portion light beam L2, so that it is unnecessary to configure two groups of light source modules to respectively correspond to the two groups of diffraction optical elements, which avails saving a volume and reduce the cost.

In the embodiment, at least one of the first portion light beam L1 and the second portion light beam L2 has a wavelength greater than or equal to 910 nm, and smaller than or equal to 970 nm. Alternatively, in the embodiment, at least one of the first portion light beam L1 and the second portion light beam L2 has a wavelength greater than or equal to 1330 nm, and smaller than or equal to 1370 nm. Generally, an irradiance of the solar spectrum is stronger in a wavelength range of visible light, but is weaker in a wavelength range of infrared light, wherein the wavelength ranging from greater than or equal to 910 nm to smaller than or equal to 970 nm and the wavelength ranging from greater than or equal to 1330 nm to smaller than or equal to 1370 nm fall within an absorption band of water vapor (H₂O) or carbon dioxide (CO₂) in the atmosphere, so that the irradiance of the sunlight on the earth's surface in the above wavelength range is weaker. Namely, if the wavelengths of the first portion light beam L1 and the second portion light beam L2 fall within the above wavelength ranges, the interference of the external sunlight may be avoided, which avails improving the accuracy of measurement.

In the embodiment, the wavelengths of the first portion light beam L1 and the second portion light beam L2 may be the same or different. If the wavelengths of the first portion light beam L1 and the second portion light beam L2 are different, mutual interference between the first portion light beam L1 and the second portion light beam L2 to affect the measurement result is avoided, so as to further improve the accuracy of measurement.

It should be noted that the light beam L emitted by the light source module 110 of the structured light projecting apparatus 100 of FIG. 1 may also have a wavelength ranging from greater than or equal to 910 nm to smaller than or equal to 970 nm, or have a wavelength ranging from greater than or equal to 1330 nm to smaller than or equal to 1370 nm. Moreover, light intensities of the first portion light beam L1 emitted by the first light-emitting portion 212 and the second portion light beam L2 emitted by the second light-emitting portion 214 of the structured light projecting apparatus 200 of FIG. 3 may be the same or different, which is not limited by the invention.

In summary, the structured light projecting apparatus of the embodiment of the invention adopts two groups of diffraction optical elements, and uses two simple ways to respectively provide the first portion light beam and the second portion light beam to the first diffraction optical element and the second diffraction optical element. The first way is to use the beam splitting element to split the light beam emitted by the light source module into the first portion light beam and the second portion light beam. The second way is that the single light source module may include the first light-emitting portion and the second light-emitting portion capable of respectively emitting the first portion light beam and the second portion light beam. Therefore, the structured light projecting apparatus of the embodiment of the invention is unnecessary to configure two groups of light source modules to respectively correspond to the two groups of diffraction optical elements, which avails saving a volume and reduce the cost. On the other hand, if the first portion light beam and the second portion light beam have wavelengths ranging from greater than or equal to 910 nm to smaller than or equal to 970 nm or have wavelengths ranging from greater than or equal to 1330 nm to smaller than or equal to 1370 nm, the interference of the external sunlight may be avoided, which avails improving the accuracy of measurement. In addition, the light intensities or wavelengths of the first portion light beam and the second portion light beam may be different, which avails improving distinguishability between the first structured light and the second structured light projected by the structured light projection apparatus, so as to improve the accuracy of measurement.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A structured light projecting apparatus, comprising:
a light source module, configured to emit a light beam;
a beam splitting element, disposed on a transmission path of the light beam, and configured to split the light beam into a first portion light beam and a second portion light beam;
a first diffraction optical element, disposed on a transmission path of the first portion light beam, wherein a plurality of light beams separated from each other are produced after the first portion light beam passes through the first diffraction optical element, so as to form a first structured light;
a second diffraction optical element, disposed beside the first diffraction optical element, and disposed on a transmission path of the second portion light beam, wherein a plurality of light beams separated from each other are produced after the second portion light beam passes through the second diffraction optical element, so as to form a second structured light;
a first lens module; and
a second lens module, the first lens module and the second lens module respectively disposed on the transmission paths of the first portion light beam and the second portion light beam, and each of the first lens module and the second lens module comprising a diverging lens and a converging lens, wherein the first lens module and the second lens module are used for at least one of light beam shaping and light beam collimation, and the first lens module and the second lens module respectively expand the first portion light beam and the second portion light beam via the respective diverging lenses.

2. The structured light projecting apparatus as claimed in claim 1, wherein the beam splitting element comprises:
a transflective element, disposed on the transmission path of the light beam, wherein the first portion light beam of the light beam is reflected by the transflective element and transmitted to the first diffraction optical element, and the second portion light beam of the light beam passes through the transflective element; and
a reflecting element, disposed on a transmission path of the second portion light beam passing through the transflective element, wherein the second portion light beam is reflected by the reflecting element and transmitted to the second diffraction optical element.

3. The structured light projecting apparatus as claimed in claim 1, wherein light intensities of the first portion light beam and the second portion light beam are the same.

4. The structured light projecting apparatus as claimed in claim 1, wherein light intensities of the first portion light beam and the second portion light beam are different.

5. The structured light projecting apparatus as claimed in claim 1, wherein the first diffraction optical element and the second diffraction optical element have different diffraction patterns.

6. A structured light projecting apparatus, comprising:
a light source module, having a first light-emitting portion and a second light-emitting portion, wherein the first light-emitting portion is configured to emit a first portion light beam, and the second light-emitting portion is configured to emit a second portion light beam;
a first diffraction optical element, disposed on a transmission path of the first portion light beam, wherein a plurality of light beams separated from each other are produced after the first portion light beam passes through the first diffraction optical element, so as to form a first structured light;
a second diffraction optical element, disposed beside the first diffraction optical element and disposed on a transmission path of the second portion light beam, wherein a plurality of light beams separated from each other are produced after the second portion light beam passes through the second diffraction optical element, so as to form a second structured light;
a first lens module; and
a second lens module, the first lens module and the second lens module respectively disposed on the transmission paths of the first portion light beam and the second portion light beam, and each of the first lens module and the second lens module comprising a diverging lens and a converging lens, wherein the first lens module and the second lens module are used for at least one of light beam shaping and light beam collimation, and the first lens module and the second lens module respectively expand the first portion light beam and the second portion light beam via the respective diverging lenses, wherein one of the following is true:
at least one of the first portion light beam and the second portion light beam has a wavelength greater than or equal to 910 nm and smaller than or equal to 970 nm; or
at least one of the first portion light beam and the second portion light beam has a wavelength greater than or equal to 1330 nm and smaller than or equal to 1370 nm.

7. The structured light projecting apparatus as claimed in claim 6, wherein wavelengths of the first portion light beam and the second portion light beam are the same.

8. The structured light projecting apparatus as claimed in claim 6, wherein wavelengths of the first portion light beam and the second portion light beam are different.

9. The structured light projecting apparatus as claimed in claim 6, wherein the first diffraction optical element and the second diffraction optical element have different diffraction patterns.
